(19) United States
(12) Patent Application Publication
(10) Pub. No.: US 2012/0088127 A1
(43) Pub. Date: Apr. 12, 2012

(54) Energy Storage And Output System

(76) Inventor: Dean Wright, Buffalo, NY (US)

(21) Appl. No.: 13/269,615

(22) Filed: Oct. 9, 2011

Related U.S. Application Data
(60) Provisional application No. 61/391,546, filed on Oct. 8, 2010.

(51) Int. Cl. H01M 10/42; H01M 2/10

(52) U.S. Cl. 429/7; 429/159

(57) ABSTRACT

An electrical power supply system is disclosed. The power supply system has an energy storage device, which may include two energy packs connected in parallel, each pack comprising two banks of cells electrically connected in parallel, and each bank comprising seven energy cells electrically connected in series. The cells may be lithium-ion cells, such as those containing LiFePo. In one embodiment of the invention, the cells are rated to deliver about 3.3 volts during normal operation.

### CROSS-REFERENCE TO RELATED APPLICATION

This application claims the benefit of priority to U.S. provisional patent application Ser. No. 61/391,546, filed on Oct. 8, 2010.

### FIELD OF THE INVENTION

The present invention relates to devices for storing energy, and in particular electrical energy.

### BACKGROUND OF THE INVENTION

Prior art systems rely on lead-acid batteries connected to an AC power inverter to ultimately provide DC electrical power at the proper voltage. When configured to provide electrical power to devices, including diagnostic equipment found in many hospitals, these lead-acid battery systems are quite heavy. In addition to being heavy, the DC battery power conversion to AC is very inefficient, and since most devices operate using a DC input, converting that AC electrical power back to DC is an additional inefficiency. Total system efficiency for these prior art systems is often in the 60% to 70% range.

### SUMMARY OF THE INVENTION

The invention may be embodied as an electrical power supply system having an energy storage device. The energy storage device has two energy packs connected in parallel, each pack comprising two banks of cells electrically connected in parallel, each bank comprising seven energy cells electrically connected in series. The cells may be lithium-ion cells, such as those containing LiFePo. In one embodiment of the invention, each cell is rated to deliver about 3.3 volts during normal operation.

The electrical power supply system may have three output ports for providing electricity supplied by the energy storage device. One or more of the output ports may be configured to deliver a voltage that is different from another of the output ports.

The electrical power supply system may have a programmable logic circuit capable of setting an output voltage of each output port. Control circuitry may be provided to set the output voltage of an output port via a duty cycle imposed by the programmable logic circuit via the control circuitry.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a schematic of storage cells arranged in a device that is in keeping with the invention; and

FIG. 2 is a schematic of the invention.

### FURTHER DESCRIPTION OF THE INVENTION

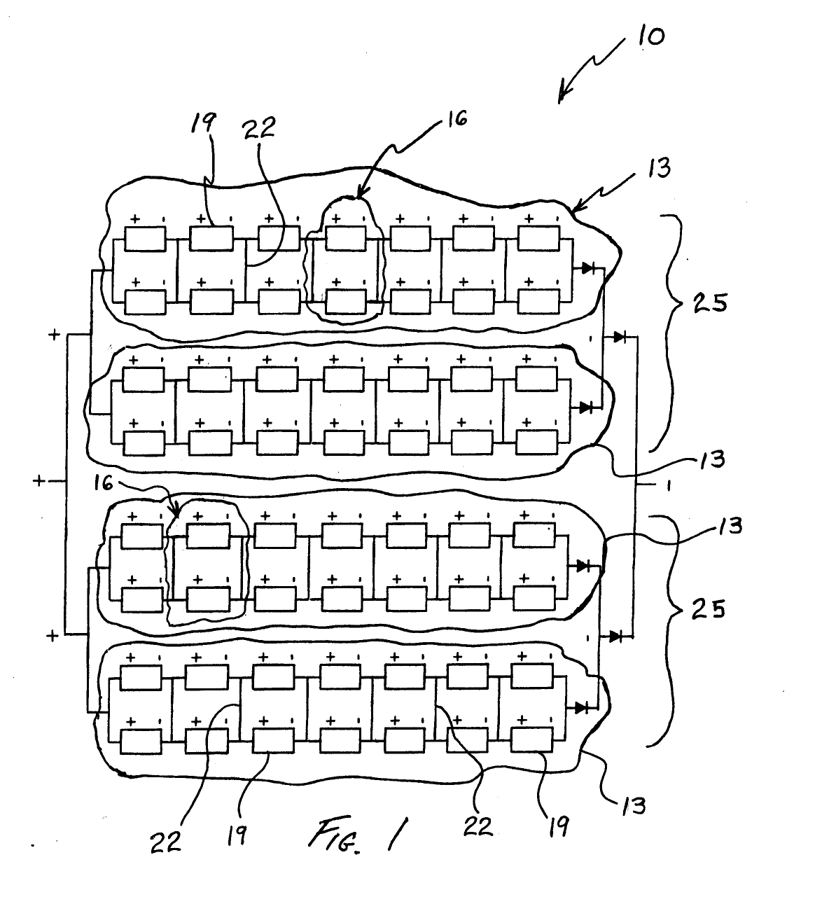

The present invention is an energy storage and output system, which may be used to provide power to (among other things) medical diagnostic equipment. FIG. 1 depicts an energy storage device (“ESD”) 10 that is in keeping with the invention. The ESD 10 that is shown in FIG. 1 has four banks 13 of cells 16. In FIG. 1, only two of the twenty-eight cells 16 are specifically called out. Each bank 13 has seven cells 16 connected in series. A cell 16 may be comprised of one or more batteries 19. In FIG. 1, three of the fifty-six batteries 19 that are shown on FIG. 1 are specifically called out. In FIG. 1, each cell 16 is shown being comprised of two batteries 19 connected in parallel via cross conductors 22. Some, but not all, of the cross conductors 22 are specifically called out in FIG. 1. In one embodiment of the invention, each cell 16 is configured to provide approximately 3.3 volts during normal operation of the ESD 10.

Two of the banks 13 may be electrically connected together in parallel to provide a first pack 25. Two other banks 13 may be electrically connected together in parallel to provide a second pack 25. The packs 25 may be electrically connected together in parallel. With this arrangement, it may be possible for the ESD 10 to provide power continuously via the output ports 28, but the invention is not limited to having both packs 25 providing power at the same time. FIG. 1 illustrates an electrical arrangement in which pairs of batteries 19 are connected in parallel to form a cell 16, seven such cells 16 are connected in series to form a bank 13, two such banks 13 are electrically connected in parallel to form a pack 25, and two such packs 25 are electrically connected in parallel to form the ESD 10.

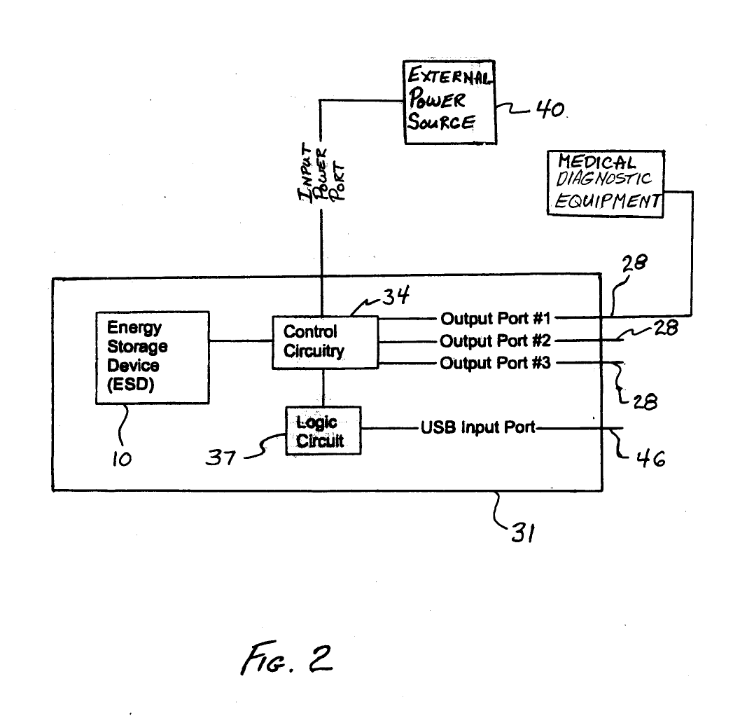

The ESD 10 may be part of a power supply system (“PSS”) 31 that includes control circuitry 34, a logic circuit 37 and output ports 28. FIG. 2 depicts such a PSS 31. When the voltage provided by a pack 25 drops below the desired output voltage for one of the output ports 28, or the current drops below the desired output current for one of the output ports 28, then the ESD 10 may be connected to an external source of power 40, and the external power source 40 may be used to supply electricity to the output ports 28 in lieu of one or more of the packs 25, and also to charge the packs 25. The packs 25 may be charged simultaneously or serially. In such a system, electrical power from the external power source 40 (which may be accessed via a standard wall outlet) may be provided to the PSS 31, and controlled by the logic circuit 37 to charge the packs 25 of the ESD 10 according to a protocol suitable for the batteries 19. If desired, the logic circuit 37 may control not only the charging protocol, but also configure the control circuit 34 to provide power (using the externally-supplied electricity as the source) to the output ports 28 at the previously programmed voltage.

Although both packs 25 may be used simultaneously, the control circuitry 34 may be configured so that one pack 25 may be in-service, while the other pack 25 is out-of-service. The pack 25 which is out-of-service may be charging, which may be accomplished by leaving that pack 25 in the ESD 10 and using the external power source 40 and the control circuitry 34. Alternatively, charging of a pack 25 may be accomplished by physically removing the pack 25 from the ESD 10, and placing that pack 25 in a charging station that is separate from the ESD 10.

Once charged, the out-of-service pack 25 may be immediately brought in-service, or may remain idle and ready for use until the voltage or current provided by the in-service pack 25 drops below a threshold level. For example, when the voltage provided by the in-service pack 25 drops below the desired output voltage for one of the output ports 28, or the current drops below the desired output current for one of the output ports 28, then the in-service pack 25 may be switched to be out-of-service, while the other pack 25 is switched to be in-service. In order to avoid a momentary loss of power, the out-of-service pack 25 may be switched to be in-service prior to switching the in-service pack 25 to out-of-service. However, charging may be accomplished by physically removing a pack 25 from the ESD, charging that pack 25, and then placing that pack 25 back in the ESD 10, whereupon that pack 25 may be immediately put back in service, or held out-of-service until needed.

The control circuit 34 may be configured to facilitate bringing a pack 25 out-of-service so that it may be removed and charged at a charging station. Alternatively, the control circuitry 34 may be configured to permit charging of an out-of-service pack 25, without removing the pack 25 from the PSS 31. In this manner, the packs 25 may be electrically connected to circuitry which allows one of the packs 25 to be charged, while the other pack 25 provides electrical power to equipment 43, such as medical diagnostic equipment, via the output ports 28.

The batteries 19 are preferably lithium-ion batteries. Each battery 19 may have a rating of 3.3 volts, and may be of the LiFePo type. Such batteries 19 may be obtained from A123 Systems of Watertown, Mass., and we have found that model #ANR26650M1A is a suitable battery 19. By using such batteries 19 arranged as described above, it has been found that portable medical diagnostic equipment 43 of the type commonly found in a hospital for monitoring patients and requiring 24 volts (or less) can be continuously powered, with proper charging of the packs 25.

The control circuitry 34 may monitor the voltage on each pack 25, and provide a warning to an operator when the voltage on a pack 25 drops below a desired threshold. As such, the operator may be informed when one of the packs 25 requires charging.

Also, the ESD 10 may provide power to three programmable output ports 28, each rated for equipment having power requirements ranging from 3 volts to 24 volts. In this manner, several pieces of equipment 43, each with different voltage requirements may be supplied with electrical power from a single ESD 10. The output from each port 28 may be set by informing a programmable logic circuit 37 about the desired output voltage. A USB port 46 may be provided for communicating with the logic circuit 37. Once the logic circuit 37 is informed of the desired output voltage for a particular output port 28, the logic circuit 37 may select and execute a routine via the control circuitry 34 that will impose a duty cycle in order to produce the desired output voltage at the desired output port 28 using electricity supplied by the ESD 10. FIG. 2 depicts such a system. In this manner, the voltage provided to an output port 28 may be set using software. Furthermore, the voltage may be adjusted without using resistors, and the associated loss of efficiency.

In a particular embodiment of the invention, three output ports 28 are provided. Two of the output ports 28 are each capable of providing an output voltage of between 3 volts and 15 volts DC at 10 amps, or an output voltage of between 15 volts and 24 volts DC at 5 amps. The third output port 28 is capable of providing an output voltage of between 3 volts and 24 volts DC at 5 amps. Such an arrangement is particularly well suited for a hospital setting in which an equipment cart may be loaded with several types of equipment 43, each having different power requirements.

The present invention is well suited to take advantage of the newest high-tech lithium-based batteries available, in order to create a system that is highly efficient. Although such batteries are expensive, the system described herein minimizes the number of those batteries that are required in order to provide the functionality and run-time that is necessary in many applications, including use in a medical facility. Furthermore, the embodiments of the invention having multiple programmable outputs allow a high degree of flexibility and usability. In addition, the inventive system approaches 90% efficiency in certain modes, and thereby represents a significant improvement over the prior art lead-acid battery systems. The increased efficiency allows for the use of lower capacity batteries 19 to provide similar run-times as the prior art lead-acid alternatives, and may allow for a weight reduction of over 50%. A PSS 31 fashioned according to the invention may weigh approximately 20 lbs, and may power three or more devices for several hours of operating time, which makes it highly desirable for powering portable medical equipment 43, such as that which is pushed by hospital nurses from room to room as part of their duties in caring for patients.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. An electrical power supply system, comprising an energy storage device having two energy packs connected in parallel, each pack comprising two banks of cells electrically connected in parallel, each bank comprising seven energy cells electrically connected in series.

2. The system of claim 1, wherein the cells are LiFePo.

3. The system of claim 1, wherein the cells each have a rating of about 3.3 volts.

4. The system of claim 1, further comprising three output ports for providing electricity supplied by the energy storage device.

5. The system of claim 4, wherein one of the output ports is able to provide a different voltage than another of the output ports.

6. The system of claim 5, further comprising a programmable logic circuit capable of setting an output voltage of each output port.

7. The system of claim 6, further comprising control circuitry, wherein setting the output voltage of an output port is accomplished via a duty cycle imposed by the programmable logic circuit via the control circuitry.
